(19) United States
(12) Patent Application Publication
(10) Pub. No.: US 2016/0153750 A1
(43) Pub. Date: Jun. 2, 2016

(54) WOODLAND CONCEALMENT PRODUCTS

(71) Applicant: Silver Eagle Homes, Inc., Ceres, CA (US)

(72) Inventors: Jarod Lee King, Ceres, CA (US); Taras Kompaniets, Voronezh (RU)

(73) Assignee: Silver Eagle Homes, Inc, Ceres, CA (US)

(21) Appl. No.: 15/016,231

(22) Filed: Feb. 4, 2016

(51) Int. Cl. F41H 3/02; B32B 5/02; B32B 7/12

(52) U.S. Cl. CPC F41H 3/02; B32B 7/12; B32B 5/02; B32B 2250/02; B32B 2255/00; B32B 2255/26; B32B 2255/02; B32B 2307/404; B32B 2307/4023

(57) ABSTRACT

A woodland concealment sheet material product like thermal blankets and duct tape includes a graphic design printed or painted on one side of a sheet material like Mylar sheets and adhesive tapes. Four rasters of random noise formed into tiles and four woodland colors are mixed according to mixing maps and two-tone image contrast levels to produce unique camouflage patterns that cannot be anticipated.

### FIELD OF THE INVENTION

The present invention relates to concealment-type survivalist gear, and more particularly to a tiled and cloth-textured camouflage-pattern graphic design applied to various sheet materials like plastic films, adhesive tapes, clothing, tents, blankets, etc.

### DESCRIPTION OF THE PRIOR ART

One object of camouflage is to be able to hide personnel and equipment behind cover from easy visual detection in the field by adversaries or prey. The basic method used is to match the colors and patterns on the camouflage to the immediate surrounds so that at a distance there are no sharp, recognizable silhouettes or outlines.

Warships and combat aircraft are routinely painted with desert, woodland, artic, blue sky, open sea, and other colors and patterns to help conceal such equipment out in the open.

### SUMMARY OF THE INVENTION

Briefly, a woodland concealment sheet material embodiment of the present invention comprises a graphic design printed or painted as camouflage on an outer side of a sheet material like Mylar thermal blanket sheets and adhesive tapes. The graphic design is uniquely generated in four overlaying colors that each begin as a raster of randomly generated noise in a standardized tile size. Gray, green, tan, and brown colors natural for woodland concealment applications are each masked by two-tone image contrast rasters. The four results are mixed in groups together with a monochrome mixing mask to produce a whole tile of woodland concealment camouflage that will conjoin seamlessly within arrays of such tiles. A further refinement visually adds a swaying cloth texture to the woodland concealment camouflage, and even faint “watermarks” of commercial trademarks.

These and other objects and advantages of the present invention no doubt become obvious to those of ordinary skill in the art after having read the following detailed description of the preferred embodiments which are illustrated in the various drawing figures.

### IN THE DRAWINGS

The patent or application file contains at least one drawing executed in color. Copies of this patent or patent application publication with color drawing(s) will be provided by the Office upon request and payment of the necessary fee.

FIG. 1A is a flowchart diagram of a graphics design method embodiment of the present invention for rendering a woodland concealment pattern that is printed, painted, or otherwise permanently deposited as color pigments on flexible sheet materials like Mylar blankets and adhesive waterproof tapes in rolls;

FIGS. 1B-1H and 1J-1M are detailed views of the various patterns included in FIG. 1A;

FIGS. 1N and 1P are 4× and 16× magnifications of small portions of the swaying cloth textured woodland concealment four-color camouflage pattern in FIG. 1M. These are presented herein to show how the regular placement of consistently sized, but darker, blobs and splotches of color give the appearance of cloth texture at stand-off distances;

FIG. 2 is a perspective view diagram of a flexible sheet material printed on one side with a whole single tile of the repeatable woodland concealment pattern produced by the Method of FIG. 1A, e.g., the pattern of FIG. 1M;

FIG. 3 is a perspective view diagram of a flexible blanket-sized Mylar sheet material printed on one side with two whole single tiles of the repeatable woodland concealment pattern seamlessly joined together along the dashed line; and

FIG. 4 is a perspective view diagram of a roll of adhesive backed duct tape printed on one side with partial tiles of the repeatable woodland concealment pattern seamlessly joined heel-to-toe along its longitudinal run.

### DETAILED DESCRIPTION OF THE PREFERRED EMBODIMENT

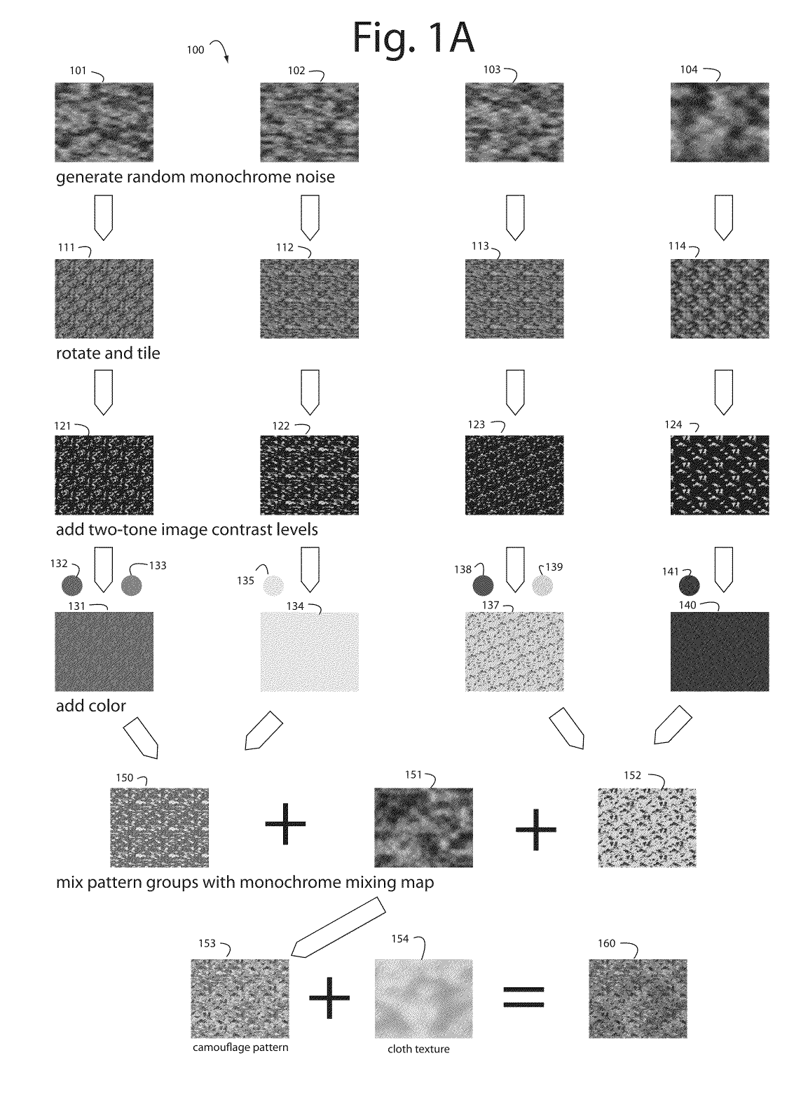

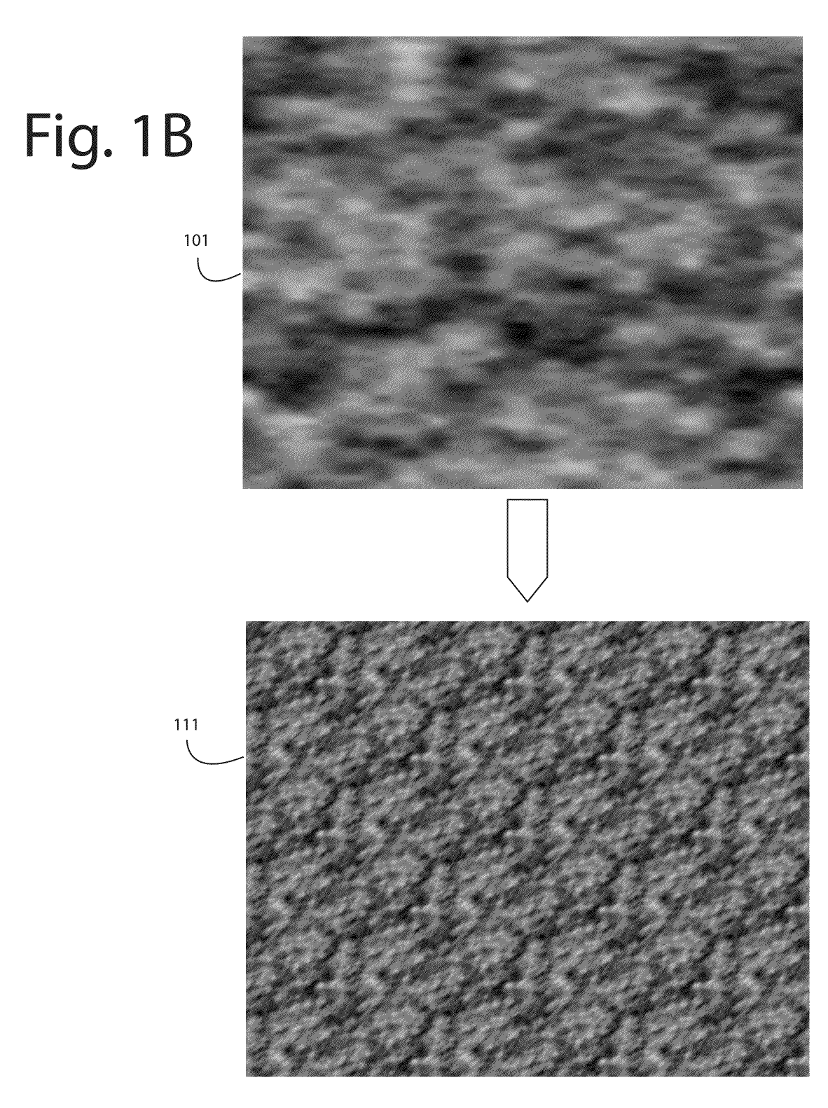

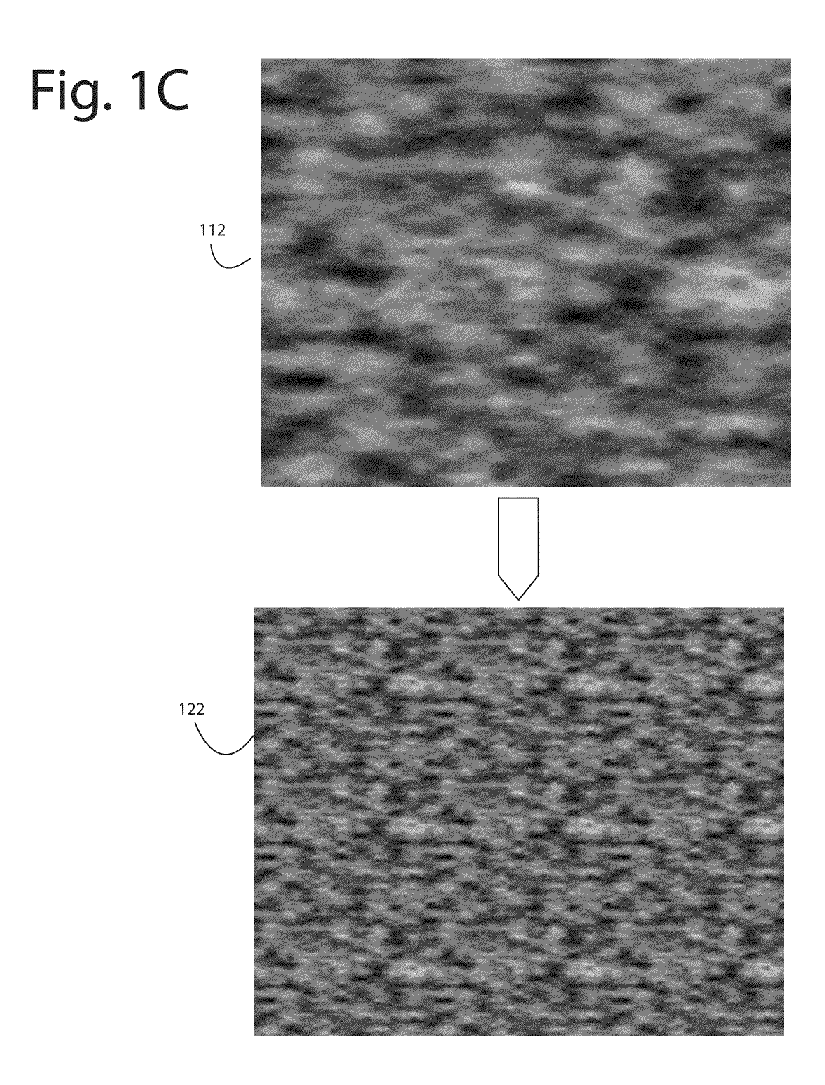

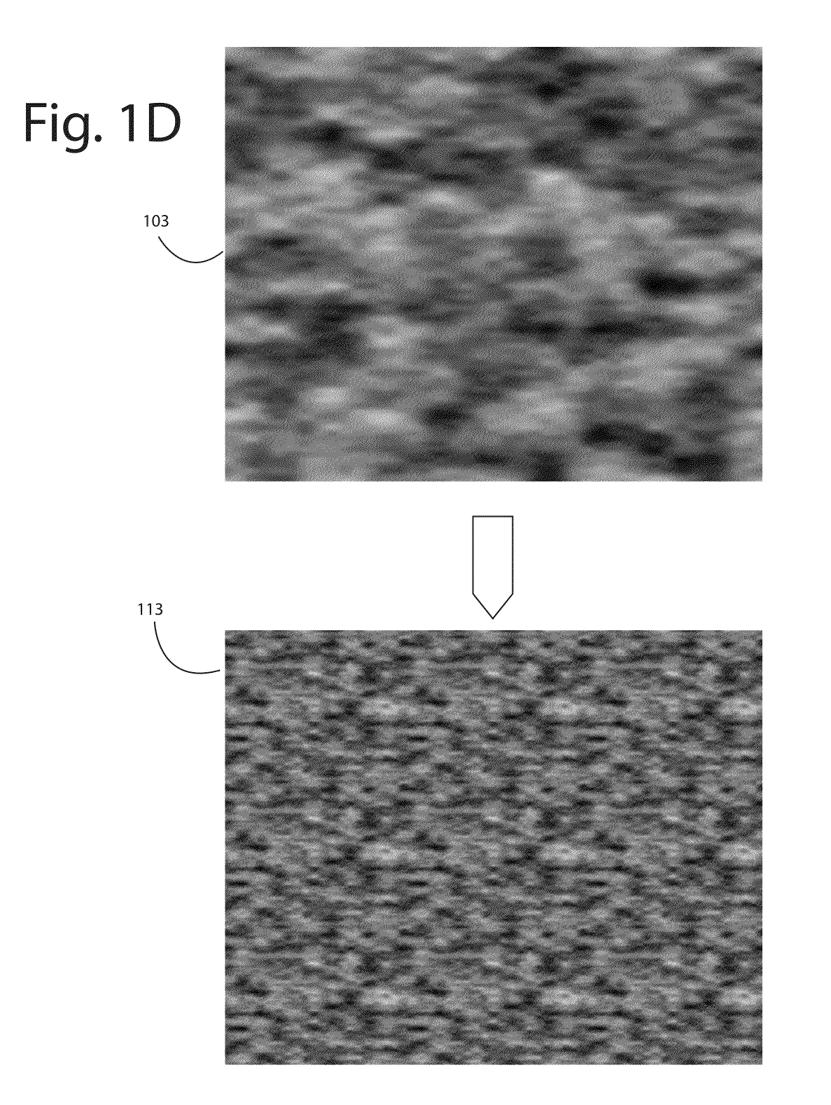

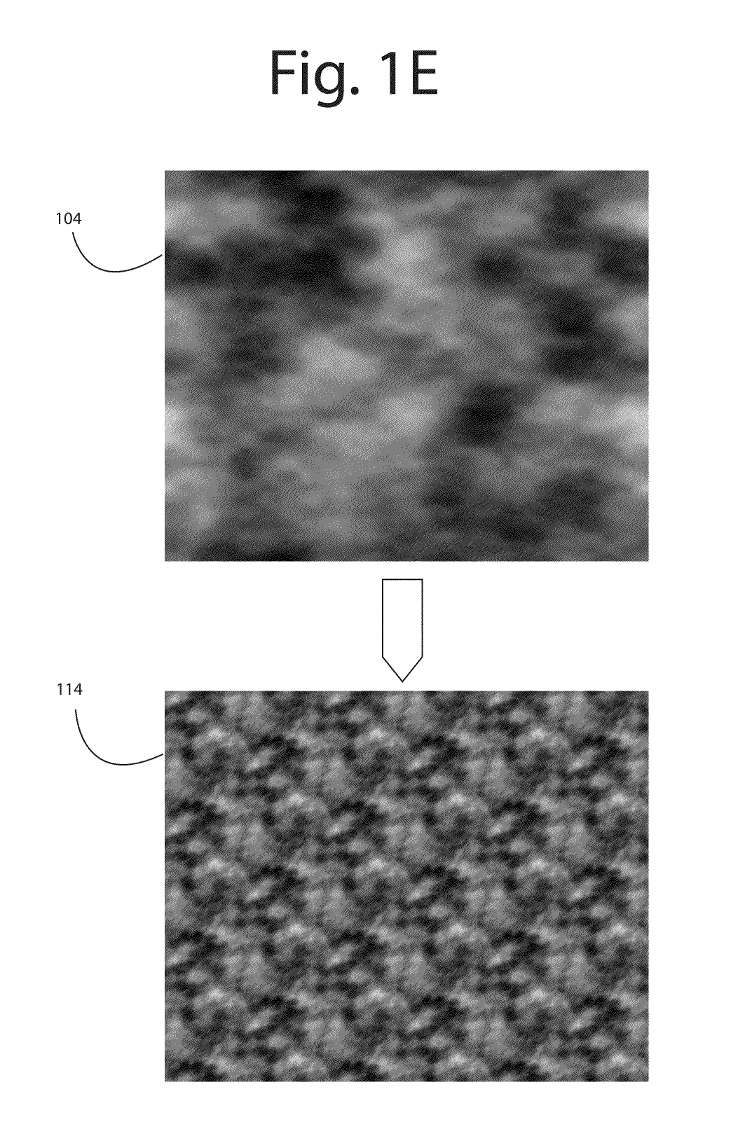

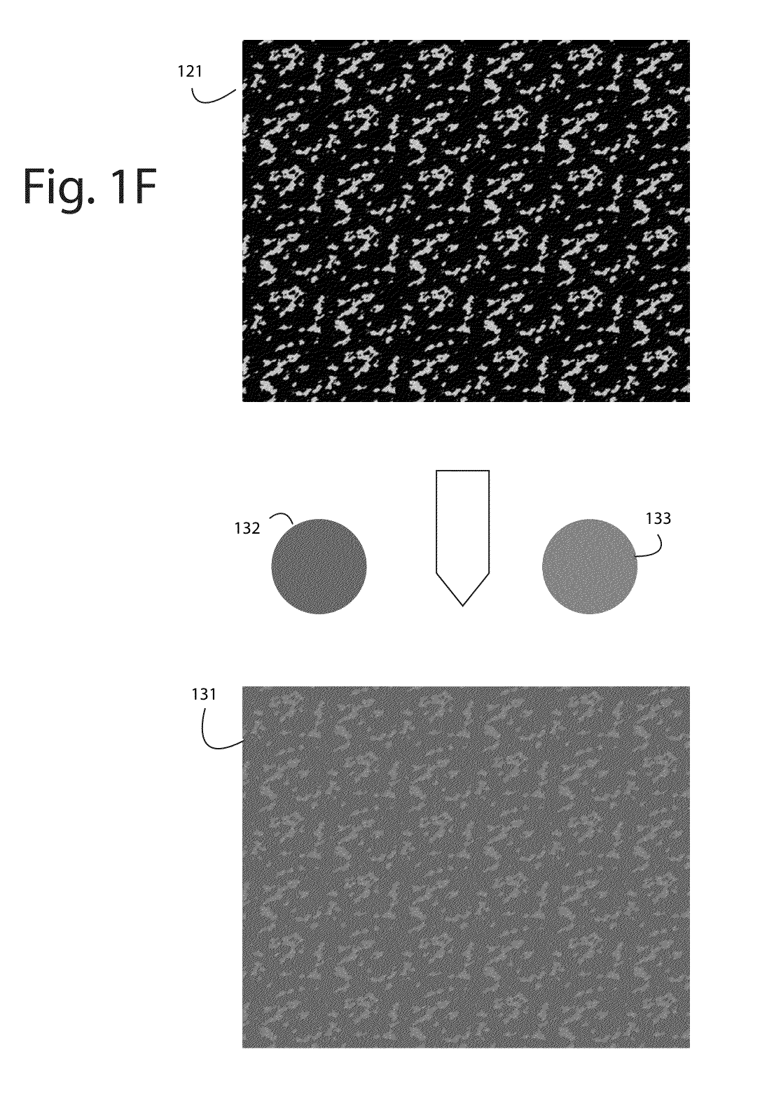

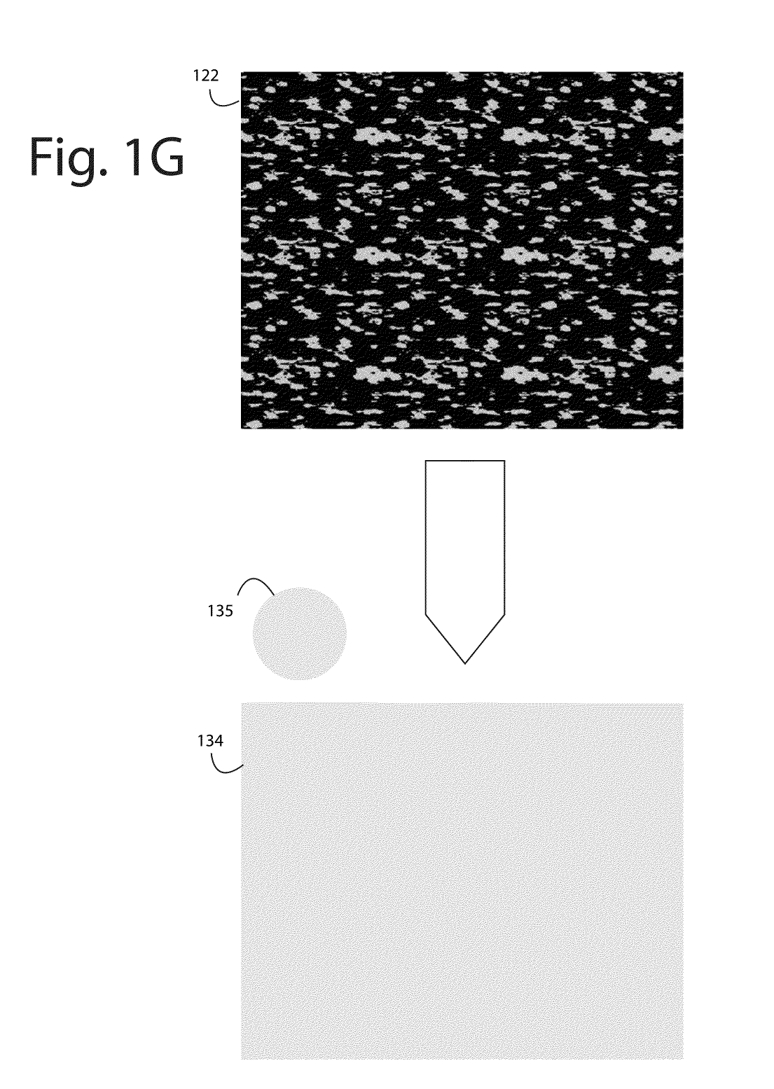

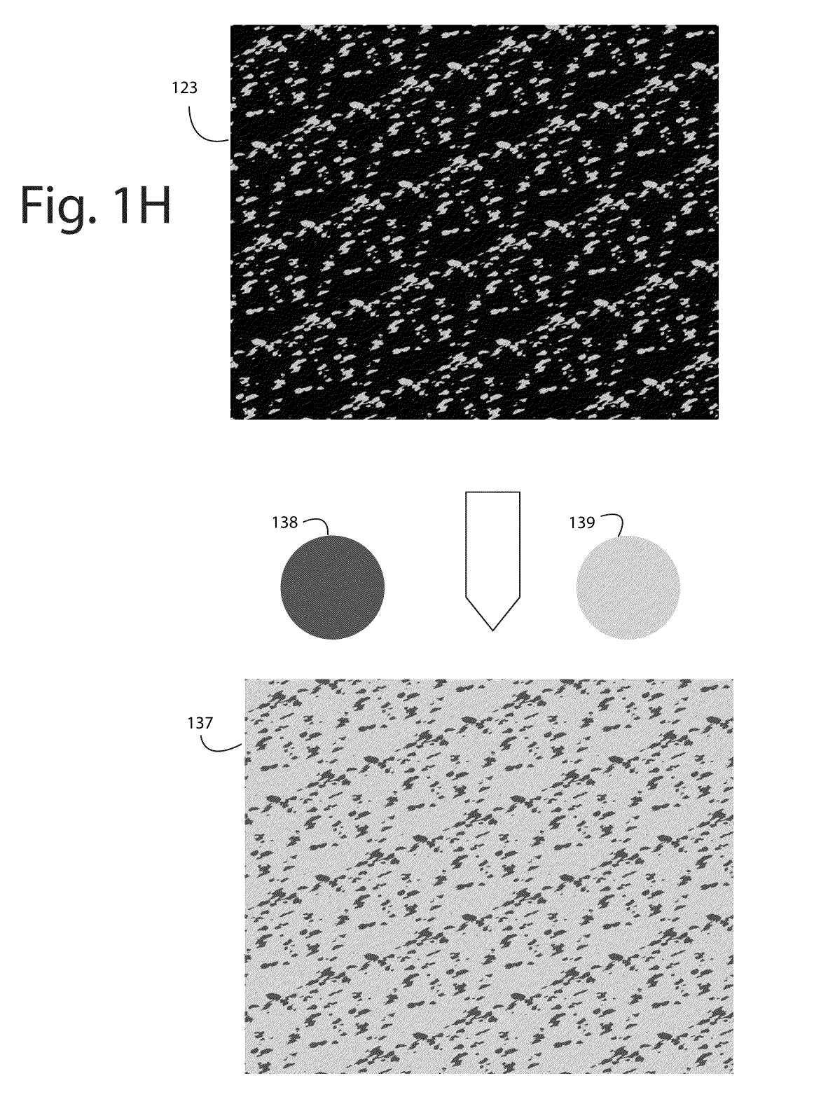

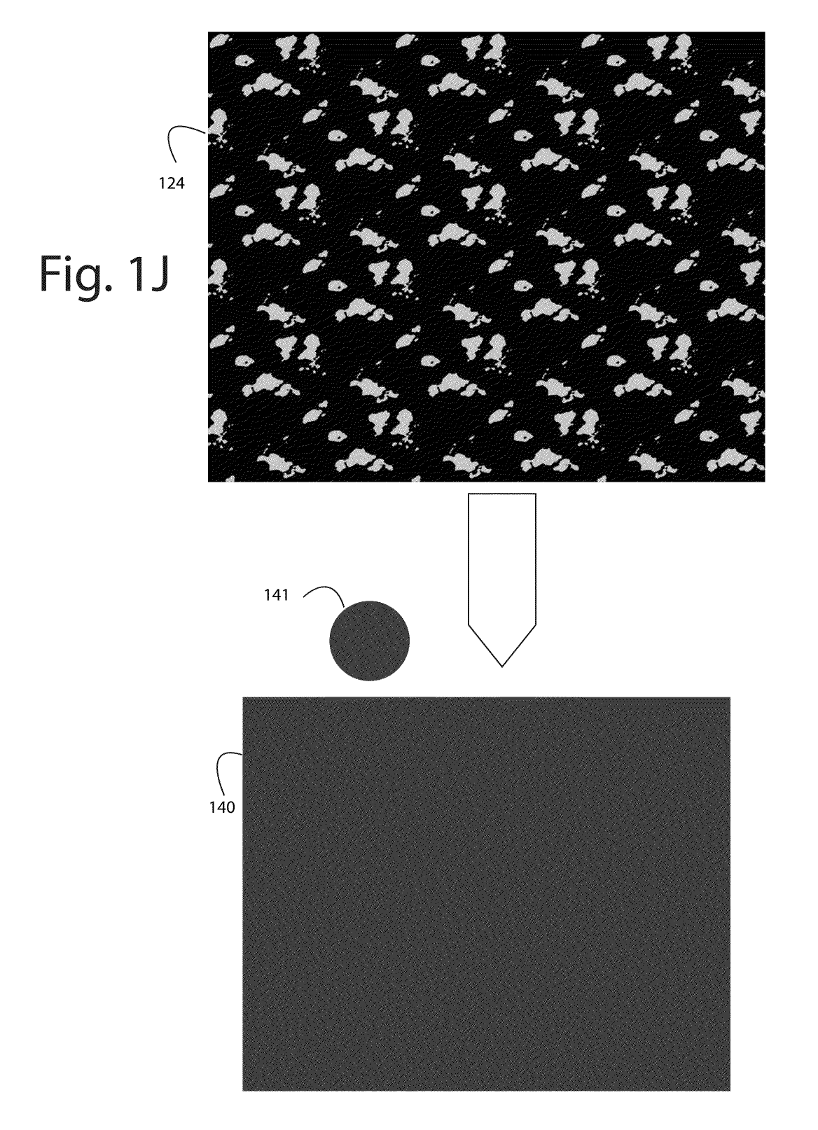

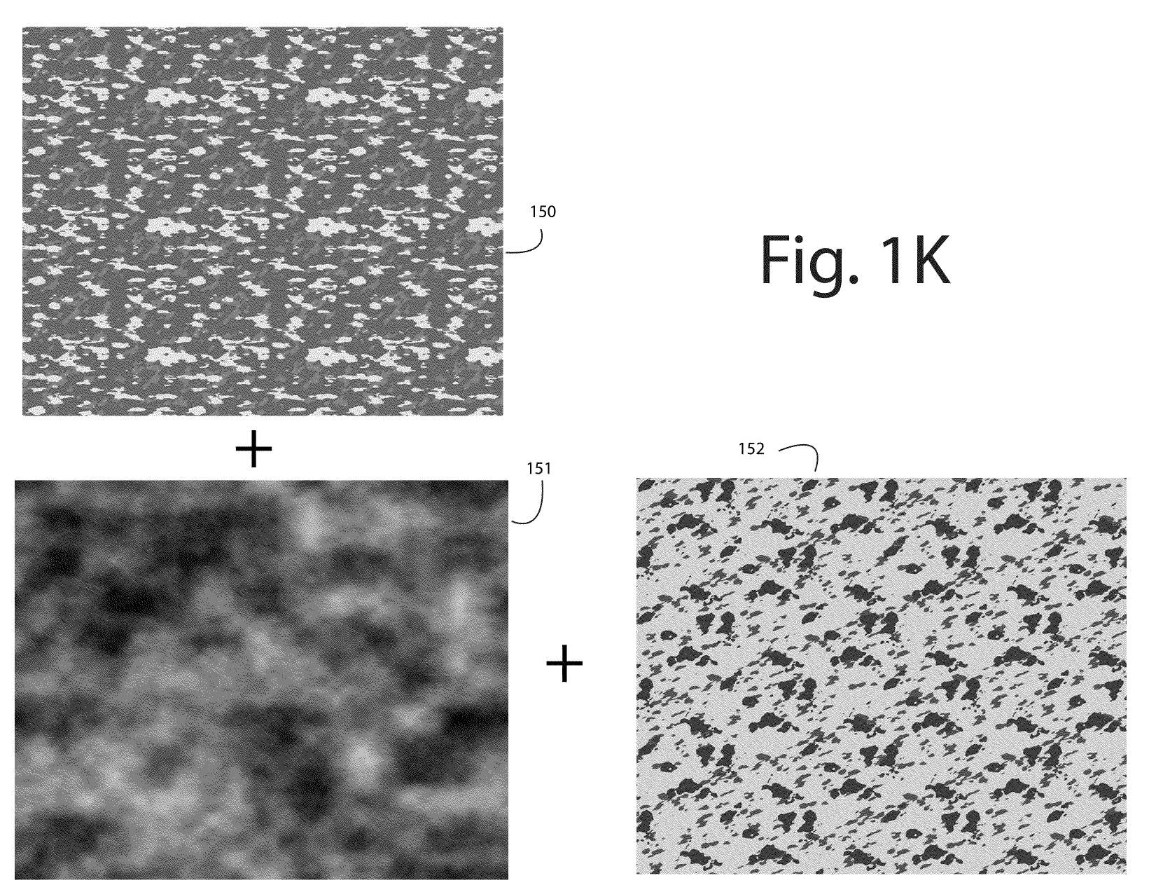

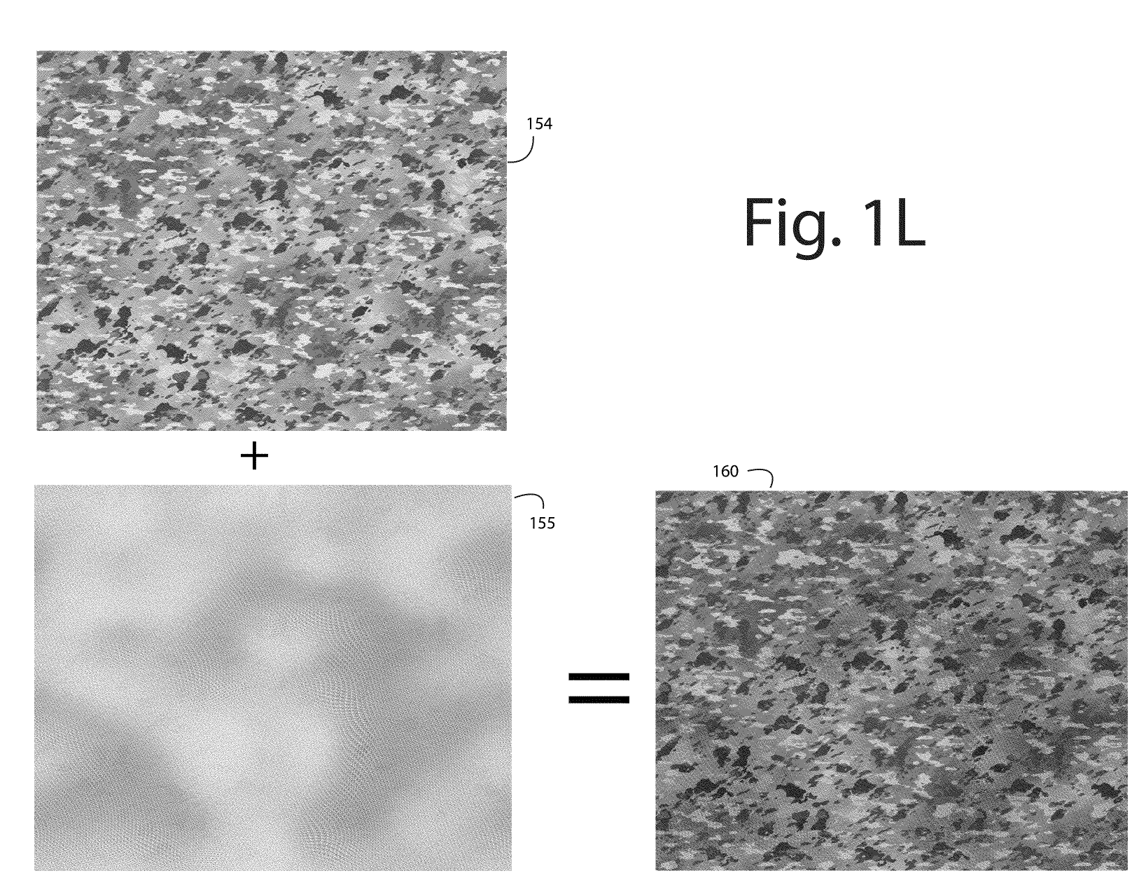

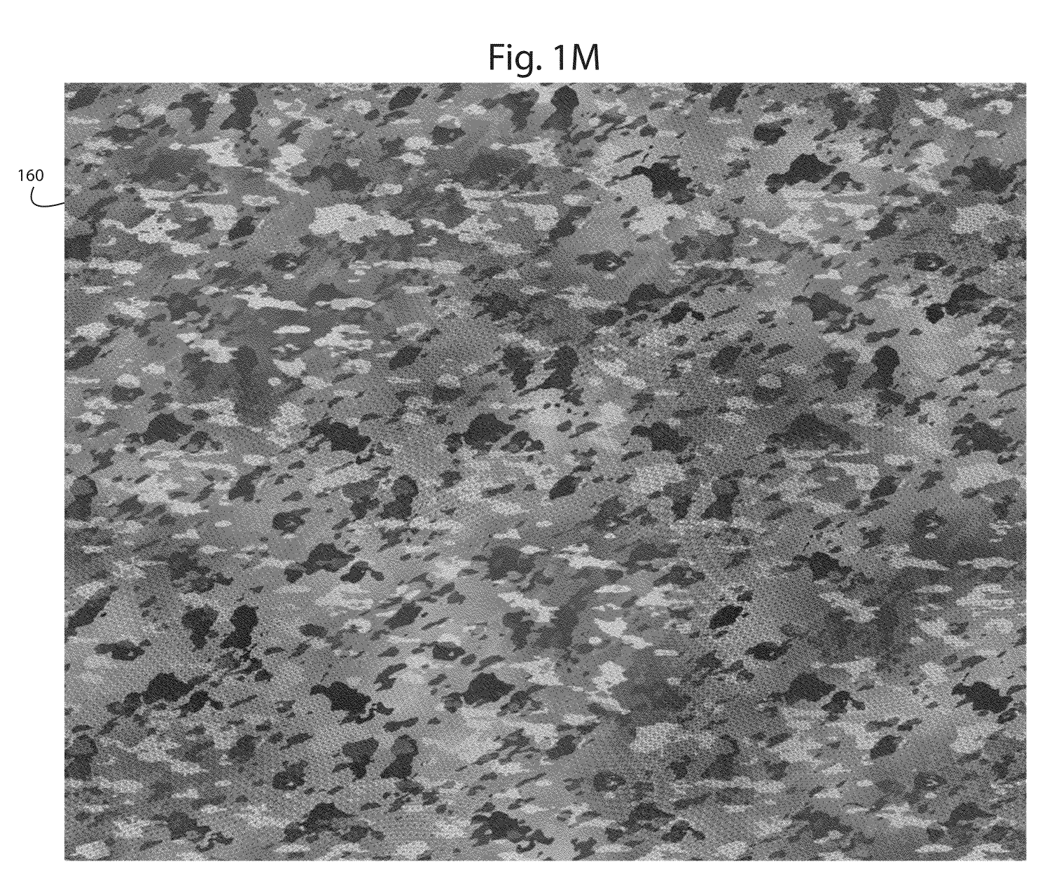

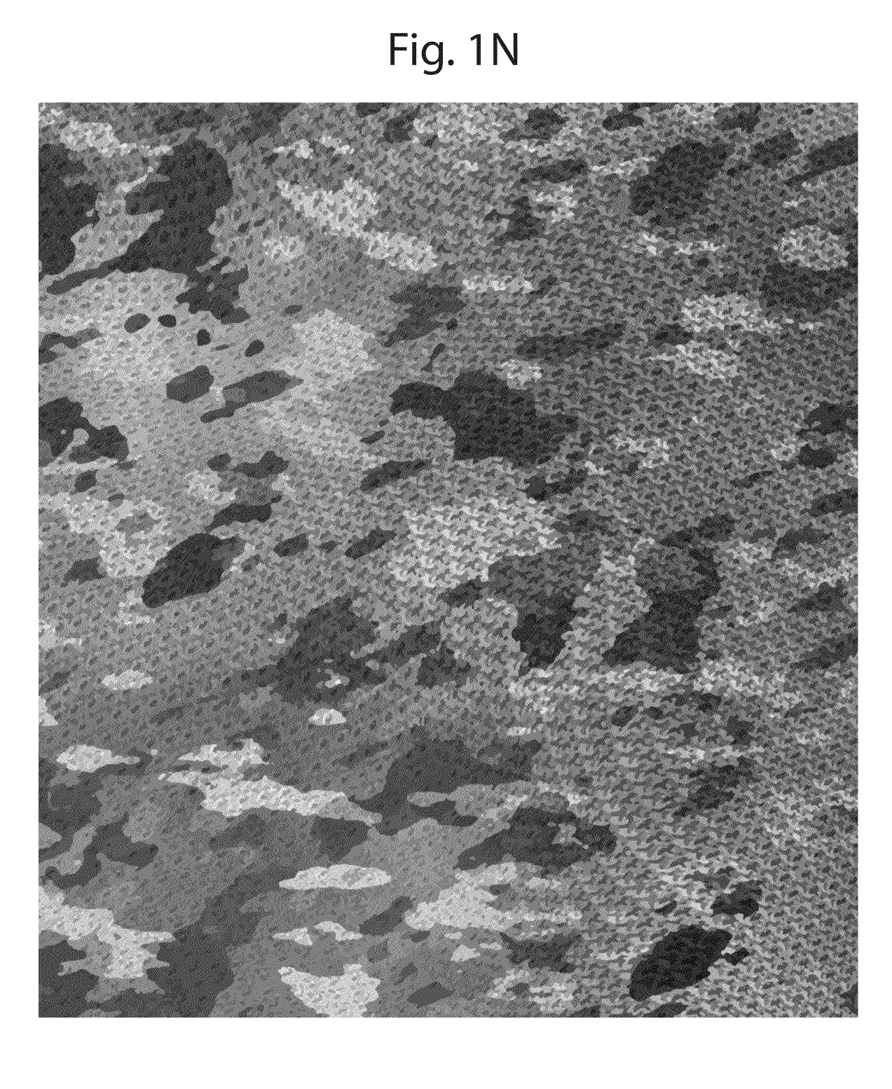

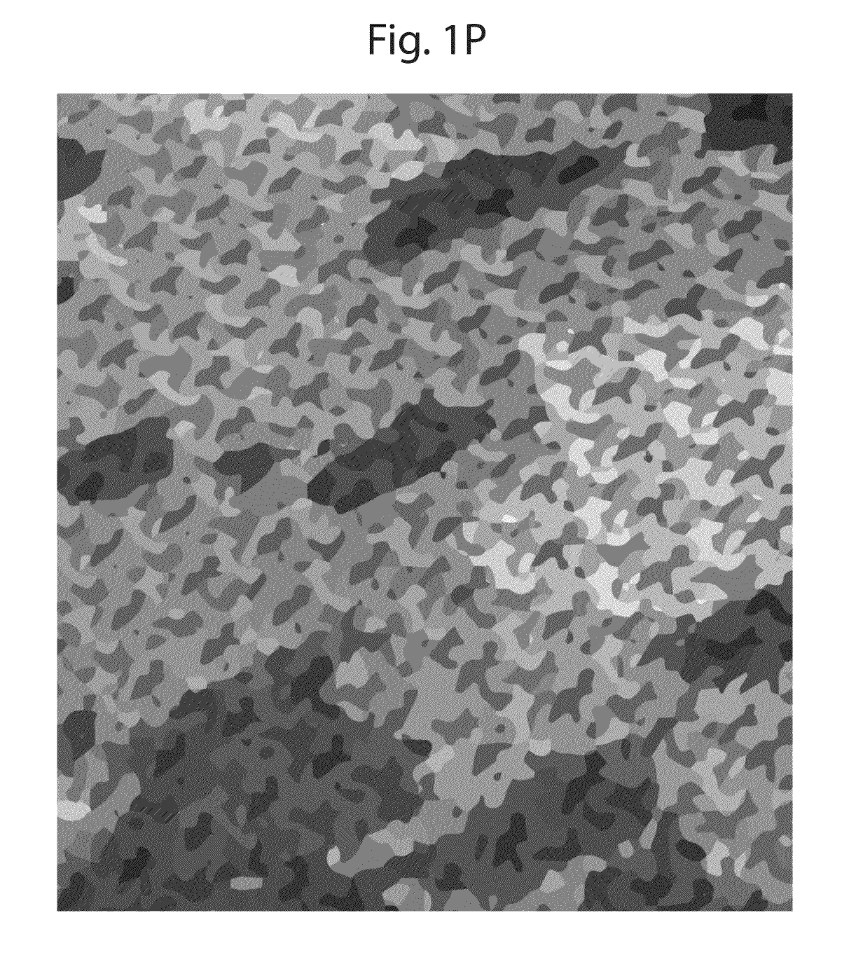

FIGS. 1A-1M represent a graphics design method 100 in an embodiment of the present invention for rendering a woodland concealment pattern that is printed or painted on flexible sheet materials like Mylar blankets and adhesive waterproof tapes in rolls. A first set of patterns 101-104 are generated from random monochrome noise using a graphics design software like Adobe Illustrator. These are individually rotated and tiled to produce a next set of patterns 111-114. Individual two-tone image contrast levels 121-124 are used to fix color transitions in each of the four pattern sets. A drab green color 131 is shifted by contrast level 121 between a darker drab green color 132 and a lighter drab green color 133. A grey color 134 is filtered by contrast level 122 to turn on or off grey color 135. A tan color 137 is shifted by contrast level 123 between a darker tan color 138 and a lighter tan color 139. A brown color 140 is filtered by contrast level 124 to turn on or off brown color 141.

Patterns 101 and 111 can be seen in much finer detail in FIG. 1B. Patterns 102 and 112 can be seen in much finer detail in FIG. 1C. Patterns 103 and 113 can be seen in much finer detail in FIG. 1D. Patterns 104 and 114 can be seen in much finer detail in FIG. 1E. Resulting pattern 131 that shifts between drab green colors 132 and 133 according to pattern 121 is presented in much finer detail in FIG. 1F. Color 134 that is filtered by pattern 122 is presented in much finer detail in FIG. 1G. Resulting pattern 137 that shifts between tan colors 138 and 139 according to pattern 123 is presented in much finer detail in FIG. 1H. Color 140 that is filtered by pattern 124 is presented in much finer detail in FIG. 1J.

A first color pattern group 150 results from adding together 121, 131, 122, and 134. A monochrome mixing map 151 is added with a second color pattern group 152 that is the sum of 123, 137, 124, and 140. See FIG. 1K. The three added together form a final four-color camouflage pattern 153. See FIG. 1L. Such can be the final step in this process, and printed on a flexible sheet material.

A swaying cloth texturing pattern 154 is added to four-color camouflage pattern 153 to further distort the repeatable patterns, as well as provide an appearance of cloth texture for printing on some Mylar blankets, duct tape, and other products. See FIG. 1L for finer details of the patterns. Such cloth texture is an option. A swaying cloth textured woodland concealment four-color camouflage pattern 160 is the final product of these steps and can be seen in finer detail in FIG. 1M. In one embodiment of the invention, the graphic design is repeated in 130-cm×105-cm rectangular virtual tiles that visually blend seamlessly with identical neighbor tiles top-bottom and left-right sides. The graphic design includes two main elements throughout, a cloth texturing using fine grid shadowing and a color of woodland color splotches and blobs that mimic natural, unoccupied woodland settings and scenery.

A further refinement visually adds a swaying cloth texture to the woodland concealment camouflage, and even faint “watermarks” of commercial trademarks plain to see or encrypted signatures and messages hidden in plain sight.

As a consequence of method 100, all the colors used cluster around shades of gray, green, brown, and drab green, olive drab, and army green, no two blobs seem to have exactly the same Cyan-Magenta-Yellow-Black (CMYK) color values. And so it could be said thousands of color shades are being used. And, because of the random noise generated rasters, no two blobs seem to have the same exact shapes, as all appear unique.

There are, however, general consistencies in blob sizes, about a dozen blob size groups. The cloth texturing occurs parallel wave lines and each virtual intersecting thread occurs at regular period longitudinal and lateral positions represented by consistently sized blobs that are a few shades darker than the larger blobs that they overlay.

FIGS. 1N and 1P are 4× and 16× magnifications of small portions of the swaying cloth textured woodland concealment four-color camouflage pattern 160 in FIG. 1M. These show how the regular placement of consistently sized, but darker, blobs and splotches of color give the appearance of cloth texture at stand-off distances.

The method 100 can be summarized in the following way and words as a method of making a woodland concealment sheet material. A first step generates a monochrome raster (101-104) of random noise for each of four colors (132, 135, 138, and 141) in a woodland camouflage color palette. A next step rotates and equally tiles each of the four random-noise monochrome rasters as four individual tiles (111-114). A further step adds to each of the four random-noise monochrome rasters (111-114) a corresponding two-tone contrast level (121-124) to the four individual tiles. A next step adds to each of the four random-noise monochrome rasters a corresponding green, grey, tan, and brown color according to its respective two-tone contrast level. A next step mixes together a pair of color pattern groups (150, 152) of the above according to a monochrome mixing map (151) to obtain a unique woodland camouflage pattern (153).

A further step prints a flexible sheet material (201, 302) with whole and partial tiles (304, 306) of the unique woodland camouflage pattern repeated as necessary to join seamlessly along each edge (308) with a neighboring tile.

An optional step adds to the unique woodland camouflage pattern (153) a visual cloth texturing raster (154), followed by printing of the combination (160).

A first plurality of overlapping and unsystematically positioned blobs, splotches, drops, spots, globules, and blotches are such that each constituent comprises a unique proportioned combination within any one rectangular shaped tile area of cyan-magenta-yellow-black color pigments in a limited range of cyan, a limited range of magenta, a limited range of yellow, and a limited range of black. These overlapping and unsystematically positioned blobs, splotches, drops, spots, globules, and blotches are such that each constituent comprises a unique shape within any one rectangular shaped tile area, and each constituent has an area size in the range of 1% to 10% of the area size of any one whole rectangular shaped tile area.

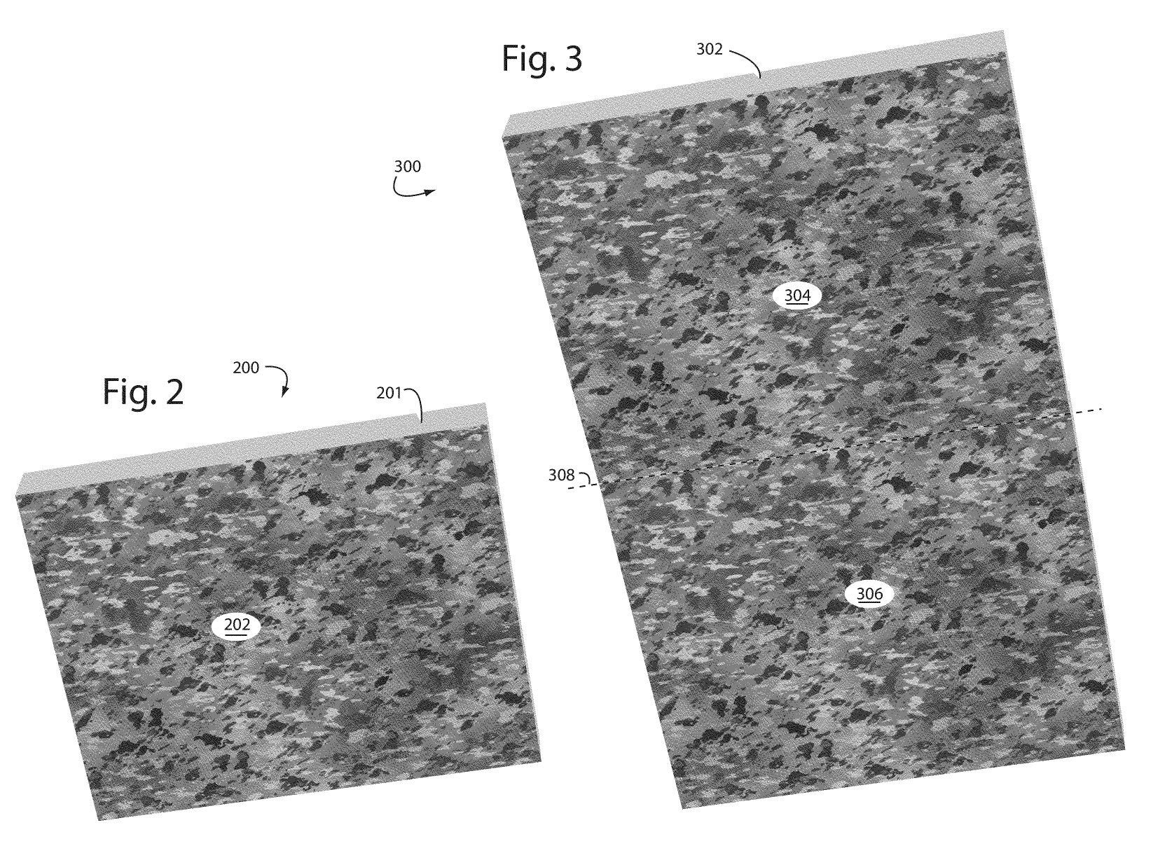

FIG. 2 represents a woodlands concealment product 200 with a base flexible sheet material 201 printed on one side with a whole single tile of the repeatable woodland concealment pattern 202 produced by the Method of FIG. 1A, e.g., the pattern of FIG. 1M. Commercial materials that can be used for the base flexible sheet material 201 include paper, vinyl, tarps, spread cloths, foils, and stickers.

FIG. 3 represents a woodlands concealment emergency blanket 300 of a flexible blanket-sized Mylar sheet material 302 printed on one side with two whole single tiles 304 and 306 of the repeatable woodland concealment pattern 160 (FIG. 1M) seamlessly joined together along the dashed line 308. Of course however many whole or partial tiles can be seamlessly assembled as tiles to suit whatever product size is commercially necessary. A typical tile will be 130-cm by 105-cm. A typical heat-reflective emergency survival blanket will be 52″ by 84″ (132-cm by 214-cm).

A similar flexible blanket-sized Mylar sheet material 302 was developed by NASA in 1964 for the US space program. That material was a thin sheet of polyethylene terephthalate (PET) plastic, and deposition coated with a metallized reflector, usually gold or silver in color, and that reflects up to 97% of radiated heat.

For use in space, polyimide substrate, e.g., KAPTON, UPILEX®, is preferred due to its resistance to the hostile space environment, large temperature range (cryogenic to −260° C. and for short excursions up to over 480° C.), low outgassing (making it suitable for vacuum use) and resistance to ultraviolet radiation. Aluminized kapton, with foil thickness of 50 and 125 μm, was used on the Apollo Lunar Module. The polyimide gives the foils their distinctive amber-gold color. Space blankets are made by vaporizing pure aluminum and vacuum depositing micron thick films onto very thin, durable plastic substrates.

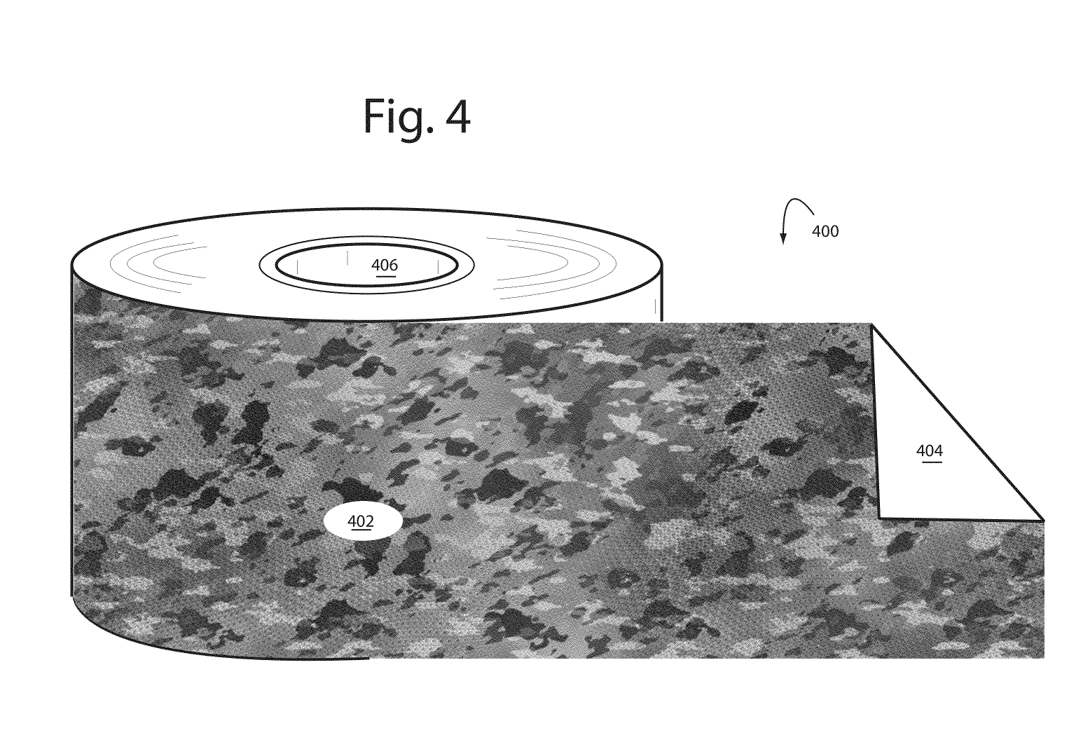

FIG. 4 is a perspective view diagram of a roll of waterproof-adhesive backed duct tape 400 printed on an outer side 402 with partial tiles of the repeatable woodland concealment pattern 160 (FIG. 1M). Such tiles are seamlessly joined heel-to-toe along its longitudinal run. The inner side 404 has a waterproof adhesive and the tape material itself is a fabric. For example, a polyethylene-coated textile fabric cut into linear strips and coiled onto rolls 406. The tape 400 can be used to join together blankets 300 without disrupting the camouflage benefits.

The “printing” of pattern 160 (FIG. 1M) onto a base material includes conventional ink stamping, ink rolling, ink jet, silk screening, laser xerography printing, spray painting, and other color pigment transfer and dye technologies.

The unique camouflage pattern 160 (FIG. 1M) can have at least two variants, e.g., what we will trademark as HUNTER'S SHROWD, and WOODLAND SHROWD, which is the same design but uses a greener color pallet. Such designs are mostly aesthetic, as its usefulness has not been proven in the field yet. Since this particular pattern has never been seen before, it is still aesthetically pleasing, and it creates a value in the eyes of buyers. One objective of the present invention is to create patterns that never have been seen before. These here can't be recreated because the baseline monochrome random noise element produces a different result each time it's executed in the method 100. An adversary's knowing what to look for when searching for a camouflaged individual befuddles easy discovery.

Duct tape 400 is similarly improved by unique camouflage pattern 160 (FIG. 1M). The many useful properties and functions of standard silver-colored duct tape are maintained, while not creating obvious unnatural reflective delineations on the material it is used on. In addition, duct tape 400 can be used to cover monotone color painted equipment such as weapons and battle helmets in situations where better concealment is preferred.

Although the present invention has been described in terms of the presently preferred embodiments, it is to be understood that the disclosure is not to be interpreted as limiting. Various alterations and modifications no doubt become apparent to those skilled in the art after having read the above disclosure. Accordingly, it is intended that the appended claims be interpreted as covering all alterations and modifications as fall within the “true” spirit and scope of the invention.

What is claimed is:

1. A woodland concealment sheet material, comprising:
a base sheet material sufficiently thin to be flexible and having inner and outer sides;
a rectangular shaped tile area at least partially disposed and at most repeatedly disposed in a tiled arrangement on the outer side of the base sheet material, and each such rectangular shaped tile area having a pair of parallel top-bottom edges and a pair of parallel left-right edges; and
a first plurality of overlapping and unsystematically positioned blobs, splotches, drops, spots, globules, and blotches each comprising color pigments restricted to muted flat earth tones of shades of gray, drab green, brown, and tans that each visually emulate a natural color found in dirt, moss, trees and rocks, and each and all disposed on the outer side of the base sheet material;
wherein, the first plurality are identically repeated in each rectangular shaped tile area, and all seamlessly blend each their overlapping and unsystematically positioned blobs, splotches, drops, spots, globules, and blotches across borders of the top-bottom and left-right edges of conjoining rectangular shaped tile area.

2. The woodland concealment sheet material of claim 1, further comprising:
a second plurality of swaying-grid positioned and consistently smaller sized blobs, splotches, drops, spots, globules, and blotches each comprising contrastingly darker color pigments restricted to muted flat earth tones of shades of gray, drab green, brown, and tans that together overlay a few larger areas of the first plurality and that faintly emulate a visual appearance of a swaying fabric on which the first plurality is disposed on the outer side of the base sheet material.

3. The woodland concealment sheet material of claim 1, further comprising:
a pressure sensitive adhesive applied to and covering the inner side of the base sheet material opposite to the outer side on which the first plurality is disposed;
wherein, the base sheet material includes a polyethylene-coated textile fabric cut into linear strips and coiled into rolls of tape.

4. The woodland concealment sheet material of claim 1, wherein, the base sheet material comprises Mylar plastic sheeting and is cut into blankets or tarps.

5. The woodland concealment sheet material of claim 1, wherein the first plurality of overlapping and unsystematically positioned blobs, splotches, drops, spots, globules, and blotches are such that each constituent comprises a unique proportioned combination within any one rectangular shaped tile area of cyan-magenta-yellow-black color pigments in a limited range of cyan, a limited range of magenta, a limited range of yellow, and a limited range of black.

6. The woodland concealment sheet material of claim 1, wherein the first plurality of overlapping and unsystematically positioned blobs, splotches, drops, spots, globules, and blotches are such that each constituent comprises a unique shape within any one rectangular shaped tile area.

7. The woodland concealment sheet material of claim 1, wherein the first plurality of overlapping and unsystematically positioned blobs, splotches, drops, spots, globules, and blotches are such that each constituent has an area size in the range of 1% to 10% of the area size of any one rectangular shaped tile area.

8. A method of making a woodland concealment sheet material, comprising:
generate a monochrome raster of random noise for each of four colors in a woodland camouflage color palette;
rotate and equally tile each of the four random-noise monochrome rasters as four individual tiles;
add to each of the four random-noise monochrome rasters a corresponding two-tone contrast level to the four individual tiles;
add to each of the four random-noise monochrome rasters a corresponding green, grey, tan, and brown color according to its respective two-tone contrast level;
mix together a pair of color pattern groups of the above according to a monochrome mixing map to obtain a unique woodland camouflage pattern; and
printing a flexible sheet material with whole and partial tiles of the unique woodland camouflage pattern repeated as necessary to join seamlessly along each edge with a neighboring tile.

9. The method of claim 8, further comprising before the step of printing:
adding to the unique woodland camouflage pattern a visual cloth texturing raster, followed by printing of the combination.
